(19) United States
(12) Patent Application Publication
(10) Pub. No.: US 2005/0276919 A1
(43) Pub. Date: Dec. 15, 2005

(54) Method for dispensing a fluid on a substrate

(75) Inventors: Van N. Truskett, Austin, TX (US); Byung-Jin Choi, Austin, TX (US); Ian M. McMackin, Austin, TX (US)

Correspondence Address: MOLECULAR IMPRINTS, INC.;KENNETH C. BROOKS, PO BOX 81536, AUSTIN, TX, 78708-1536, US

(73) Assignee: Molecular Imprints, Inc., Austin, TX (US)

(21) Appl. No.: 10/858,566

(22) Filed: Jun. 1, 2004

(51) Int. Cl. B05D 5/00

(52) U.S. Cl. 427/230; 427/256

(57) ABSTRACT

The present invention includes a method of forming a liquid layer on a substrate that features contacting a template with a volume. The volume is selected to minimize, if not avoid, shedding of the liquid under force of gravity. In this manner, the template may be positioned to be spaced-apart from an adjacent surface upon which the volume of liquid is to be transferred, with the volume being suspended by surface tension with the template.

### BACKGROUND OF THE INVENTION

The field of invention relates generally to micro-fabrication of structures. More particularly, the present invention is directed to a method of applying liquid in furtherance of patterning substrates to form structures.

Micro-fabrication involves the fabrication of very small structures, e.g., having features on the order of micro-meters or smaller. One area in which micro-fabrication has had a sizeable impact is in the processing of integrated circuits. As the semiconductor processing industry continues to strive for larger production yields while increasing the circuits per unit area formed on a substrate, micro-fabrication becomes increasingly important. Micro-fabrication provides greater process control while allowing increased reduction of the minimum feature dimension of the structures formed. Other areas of development in which micro-fabrication has been employed include biotechnology, optical technology, mechanical systems and the like.

An exemplary micro-fabrication technique is commonly referred to as imprint lithography and is described in detail in numerous publications, such as U.S. published patent applications 2004/0065976, entitled METHOD AND A MOLD to ARRANGE FEATURES ON A SUBSTRATE to REPLICATE FEATURES HAVING MINIMAL DIMENSIONAL VARIABILITY; 2004/0065252, entitled METHOD OF FORMING A LAYER ON A SUBSTRATE to FACILITATE FABRICATION OF METROLOGY STANDARDS; 2004/0046271, entitled METHOD AND A MOLD to ARRANGE FEATURES ON A SUBSTRATE to REPLICATE FEATURES HAVING MINIMAL DIMENSIONAL VARIABILITY, all of which are assigned to the assignee of the present invention. The fundamental imprint lithography technique as shown in each of the aforementioned published patent applications includes formation of a relief pattern in a polymerizable layer and transferring the relief pattern into an underlying substrate, forming a relief image in the substrate. To that end, a template is employed spaced-apart from the substrate with a formable liquid present between the template and the substrate. The liquid is solidified forming a solidified layer that has a pattern recorded therein that is conforming to a shape of the surface of the template in contact with the liquid. The substrate and the solidified layer are then subjected to processes to transfer, into the substrate, a relief image that corresponds to the pattern in the solidified layer.

One manner in which the polymerizable liquid is located between the template and the substrate is by depositing a plurality of droplets of the liquid on the substrate. Thereafter, contact is made with the polymerizable liquid by the template to spread the polymerizable liquid over the surface of the substrate and subsequently record a pattern therein. It is highly desirable to avoid trapping of gases, such as air, when the polymerizable liquid spreads over the substrate.

It is desired, therefore, to provide a method for forming a fluid layer on a substrate while minimizing the trapping of gases therein.

### SUMMARY OF THE INVENTION

The present invention includes a method of forming a liquid layer on a substrate that features contacting a template with a volume. The volume is selected to minimize, if not avoid, shedding of the liquid under force of gravity. In this manner, the template may be positioned to be spaced-apart from an adjacent surface upon which the volume of liquid is to be transferred, with the volume being suspended by surface tension with the template. These and other embodiments are discussed more fully below.

### BRIEF DESCRIPTION OF THE DRAWINGS

FIG. 1 is a perspective view of a lithographic system in accordance with the present invention;

FIG. 2 is a simplified elevation view of a lithographic system, shown in FIG. 1, employed to create a patterned imprinting layer in accordance with the present invention;

FIG. 3 is a simplified representation of material from which a patterned imprinting layer, shown in FIG. 2, is comprised before being polymerized and cross-linked in accordance with the present invention;

FIG. 4 is a simplified representation of cross-linked polymer material into which the material, shown in FIG. 3, is transformed after being subjected to radiation in accordance with the present invention;

FIG. 5 is a detailed side view showing the fluid dispense mechanism included in the system, shown in FIG. 1, in accordance with a first embodiment;

FIG. 6 is a detailed side view showing the fluid dispense mechanism included in the system, shown in FIG. 1, in accordance with a second embodiment;

FIG. 7 is a simplified elevation view of an imprint device spaced-apart from the patterned imprinting layer, shown in FIG. 1, after patterning in accordance with the present invention;

FIG. 8 is a simplified elevation view of formation of a multi-layered structure on a solidified imprinting layer, shown in FIG. 7, by deposition of a conformal layer, adjacent to the patterned imprinting layer, employing a mold in accordance with one embodiment of the present invention;

FIG. 9 is a simplified elevation view after a blanket etch of the multi-layered structure, shown in FIG. 8, to form a crown surface in the conformal layer with portions of the patterned imprinting layer being exposed in accordance with one embodiment of the present invention;

FIG. 10 is a simplified elevation view showing formation of a planarization layer in accordance with an alternate embodiment of the present invention;

FIG. 11 is a simplified plan view of a radiation source employed in the lithographic system, shown in FIG. 1, depicting dual radiation sources;

FIG. 12 is a simplified plan view of a radiation source employed in the lithographic system, shown in FIG. 1, depicting single radiation source;

FIG. 13 is a cross-sectional view of a substrate, shown in FIGS. 1, 2, 7, 8, 9 and 10, showing an infra-red absorption layer in accordance with the present invention;

FIG. 14 is a cross-sectional view of a substrate, shown in FIGS. 1, 2, 7, 8, 9 and 10, showing an infra-red absorption layer in accordance with an alternate embodiment of the present invention;

FIG. 15 is a cross-sectional view showing a release layer and a planarization layer that may be employed in accordance with the present invention; and

FIG. 16 is a cross-sectional view showing a release layer applied to a planarization mold, shown in FIG. 14.

### DETAILED DESCRIPTION OF THE INVENTION

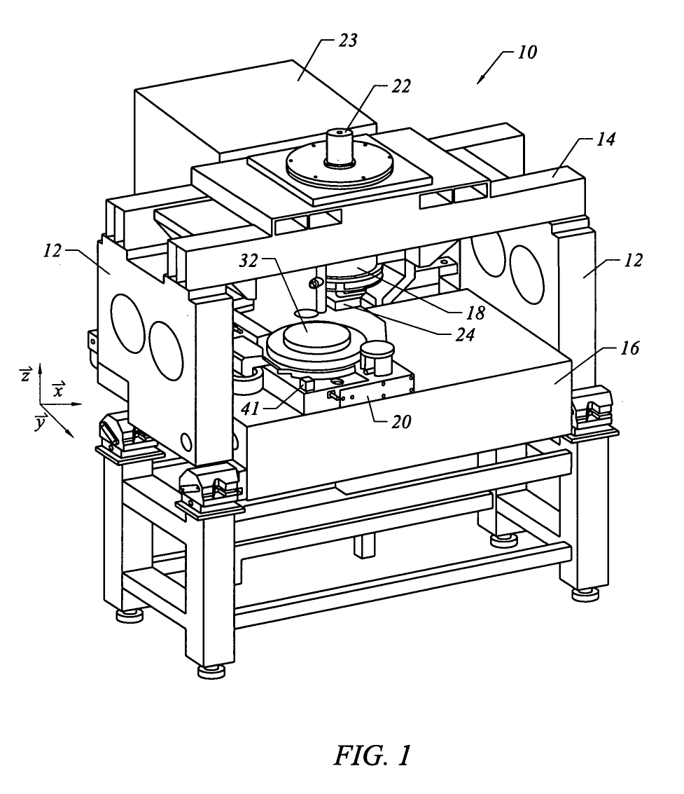

FIG. 1 depicts a lithographic system 10 in accordance with one embodiment of the present invention that includes a pair of spaced-apart bridge supports 12 having a bridge 14 and a stage support 16 extending therebetween. Bridge 14 and stage support 16 are spaced-apart. Coupled to bridge 14 is an imprint head 18, which extends from bridge 14 toward stage support 16. Disposed upon stage support 16 to face imprint head 18 is a motion stage 20. Motion stage 20 is configured to move with respect to stage support 16 along. X- and Y-axes and may provide movement along the Z-axis as well. A radiation source 22 is coupled to system 10 to impinge actinic radiation upon motion stage 20. As shown, radiation source 22 is coupled to bridge 14 and includes a power generator 23 connected to radiation source 22.

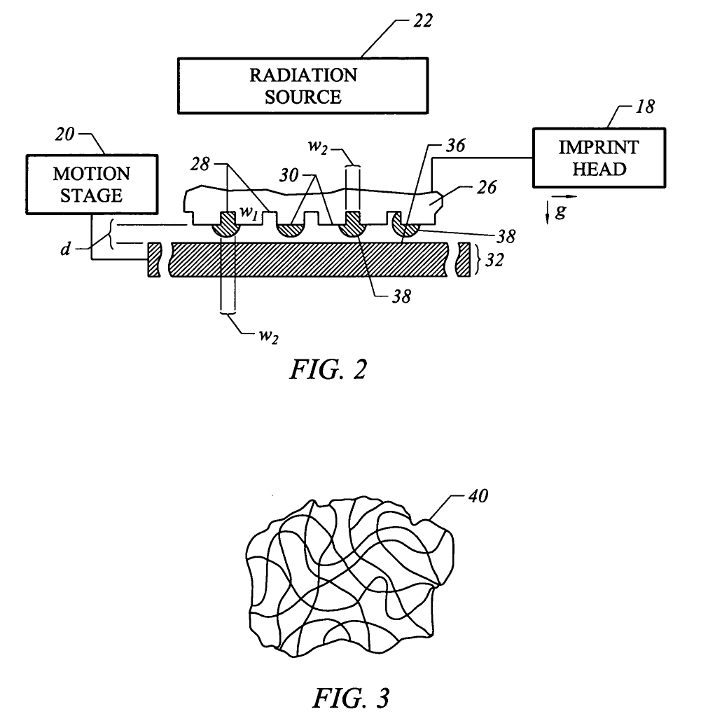

Referring to both FIGS. 1 and 2, connected to imprint head 18 is a template 24 having a patterned mold 26 thereon. An exemplary template 24 is shown in U.S. Pat. No. 6,696,220. Patterned mold 26 includes a plurality of features defined by a plurality of spaced-apart recesses 28 and projections 30. Projections 30 have a width W₁, and recesses 28 have a width W₂, both of which are measured in a direction that extends transversely to the Z-axis. The plurality of features defines an original pattern that forms the basis of a pattern to be transferred into a substrate 32 positioned on motion stage 20. To that end, imprint head 18 is adapted to move along the Z-axis and to vary a distance “d” between patterned mold 26 and substrate 32. Alternatively, or in conjunction with imprint head 18, motion stage 20 may move template 24 along the Z-axis. In this manner, the features on patterned mold 26 may be imprinted into a flowable region of substrate 32, discussed more fully below. Radiation source 22 is located so that patterned mold 26 is positioned between radiation source 22 and substrate 32. As a result, patterned mold 26 is fabricated from material that allows it to be substantially transparent to the radiation produced by radiation source 22. An exemplary system is available under the trade name IMPRIO 1000™ from Molecular Imprints, Inc. having a place of business at 1807-C Braker Lane, Suite 100, Austin, Tex. 78758. The system description for the IMPRIO 100™ is available at www.molecularimprints.com and is incorporated herein by reference.

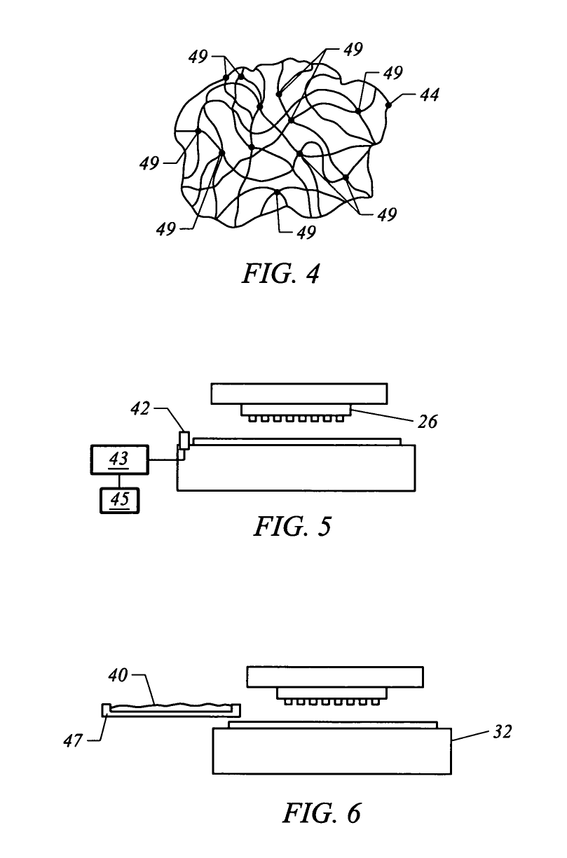

Referring to both FIGS. 2 and 3, substrate 32 is patterned with a formable material that may be selectively solidified. To that end, a plurality of spaced-apart discrete droplets 38 of a material 40 are deposited on mold 26, discussed more fully below. Material 40 may be selectively polymerized and cross-linked to record, on substrate 32, an inverse of the original pattern therein, defining a recorded pattern, shown as an imprinting layer 34. Material 40 is shown in FIG. 4 as being cross-linked at points 49, forming cross-linked polymer material 44.

Referring to FIGS. 2, 3 and 5, the pattern recorded in imprinting layer 34 is produced, in part, by mechanical contact of droplets 38 with both substrate 32 and patterned mold 26. To that end, the distance “d” is reduced to allow droplets 38 to come into mechanical contact with substrate 32, spreading droplets 38 so as to form imprinting layer 34 with a contiguous formation of material 40 over surface 36 of substrate 32. In one embodiment, distance “d” is reduced to allow sub-portions 46 of imprinting layer 34 to ingress into and fill recesses 28.

In the present embodiment, sub-portions 48 of imprinting layer 34 in superimposition with projections 30 remain after the desired, usually minimum distance “d,” has been reached, leaving sub-portions 46 with a thickness t₁ and sub-portions 48 with a thickness t₂. Thickness t₂ is referred to as a residual thickness. Thicknesses “t₁” and “t₂” may be any thickness desired, dependent upon the application. The total volume contained in droplets 38 may be such so as to minimize, or to avoid, a quantity of material 40 from extending beyond the region of surface 36 in superimposition with patterned mold 26, while obtaining desired thicknesses t₁ and t₂.

Referring to FIGS. 2, 3, and 4, after a desired distance “d” has been reached, radiation source 22 produces actinic radiation that polymerizes and cross-links material 40, forming cross-linked polymer material 44. As a result, the composition of imprinting layer 34 transforms from material 40 to material 44, which is a solid. Specifically, material 44 is solidified to form a solidified imprinting layer 134 with a side having a shape that conforms to a shape of a surface 50 of patterned mold 26, shown more clearly in FIG. 5. As a result, solidified imprinting layer 134 is formed having recessions 52 and protrusions 54. After formation of solidified imprinting layer 134, distance “d” is increased so that patterned mold 26 and solidified imprinting layer 134 are spaced-apart. This process may be repeated several times to pattern different regions (not shown) of substrate 32, referred to as a step and repeat process. An exemplary step and repeat process is disclosed in published U.S. patent application No. 2004/0008334, entitled STEP AND REPEAT IMPRINT LITHOGRPAHY SYSTEMS, which is assigned to the assignee of the present invention and is incorporated by reference herein.

Referring to FIGS. 1, 2, 3 and 5, to facilitate deposition of droplets 38 on mold 26, system 10 includes one or more fluid dispensing mechanisms 41. As shown, fluid dispensing mechanism 41 includes a spray nozzle 42 in fluid communication with a supply 43 of material 40 and a pump 45. Pump 45 provides fluid pressure to facilitate projection of material 40 from nozzle 42, ensuring droplets 38 accumulate on mold 26. Nozzle 42 is mounted to motion stage 20 to facilitate having nozzle 42 to be selectively placed in superimposition with any portion of mold 26. In this manner, droplets 38 may be deposited on mold 26 in any pattern desired. Typically surface 50 of mold 26 upon which droplets 38 are disposed faces in a direction of gravity g. As a result, droplets 38 are formed on mold 26 with a volume that is selected so that material 40 in each of droplets 38 minimizes, if not avoids, shedding. For purposes of the present invention, shedding is defined as a portion of material 40 in droplets 38 separating under force of gravity. To that end, for a given material 40 the volume is selected so that the mass of each of droplets 38 is not greater than a surface tension of the material 40 to mold 26. This allows precise control of the volume of material 40 that will ultimately form imprinting layer 34, as well as precise placement of droplets 38 on mold 26. In a further embodiment, droplets 38 may be deposited upon surface 36 of substrate 32 as well as mold 26. Additionally, an actinic radiation curable spin-coating layer (not shown) may be present on substrate 32 and droplets 38 on mold 26 are placed in contact therewith to spread over a region of the spin-coating layer (not shown).

Control of placement of droplets 38 provides many advantages, including a reduction in the time required to cover the features of mold 26, e.g., filling of recessions 28. This is often referred to as the fill time. An exemplary deposition technique that reduces fill time, includes depositing all or a portion of droplets 38 into recesses 28. The resulting capillary forces of the material 40 in droplet 38 would facilitate the filling of the recesses 28. One manner in which to achieve capillary filling of recesses 28 is to ensure that the volume associated with one of more of a plurality of droplets 38 is less than a volume of recesses 28. However, the aggregate volume of the plurality of droplets 38 would be sufficient to form imprinting layer 34 with desired thicknesses t₁ and t₂, while accurately recording an inverse of the pattern on mold 26 therein.

Another benefit with the present invention is that it facilitates varying the density of the droplets/unit area of mold 26 to compensate for differing feature density of the pattern in mold 26. For example, were a great number of recessions 28 per unit area present in one region of mold, a greater volume of material 40 may be deposited in this region as compared with other regions of the pattern on mold 26. This would require less fill time as compared with providing surface 50 with a uniform distribution of droplets 38 having equal volumes of material. With such a uniform distribution of droplets 38, the time required for material 40 to spread and to cover mold 26 is increased. This results from having to redistribute the aggregate volume of material 40 contained in droplets 38 upon decreasing distance d to obtain desired thicknesses t₁ and t₂ in imprint layer 34. For example, consider mold 26 having a pattern with features density that varies over an area thereof. Evenly distributing the aggregate volume of material 40 contained in droplets 38 over the area of mold 26 could result in an excess amount of material 40 being present in some regions of mold 26 and a dearth of material 40 being present in other regions thereof. To obtain a desired imprinting layer 34, it may be necessary to redistribute material 40 over surface 26 to have the desired quantity of material 40 between mold 26 and substrate 32. This redistribution of material 40 increases the fill time. With the present deposition process, the density of volume of material per unit area may be arranged on mold 26 to compensate for differing feature densities present in the pattern on mold 26. This may be accomplished by increasing the number of droplets 38 per unit area and/or changing the volume of material 40 in individual droplets 38. In this manner, the amount of redistribution of material 40 required to form imprinting layer 34 is reduced, thereby minimizing the fill time. Desired distribution of material 40, may be based upon real-time or a priori knowledge of the differing features densities present in the pattern on mold 26. For example, information concerning the pattern may be stored in a computer readable memory (not shown) as data. The data may be operated on by a microprocessor (not shown) to which controls the dispensing system 41 to dispense material 40 accordingly.

Another manner by which to reduce fill time would be to apply material 40 as a film over the area thereof. This obviates depositing material 40 as a plurality of droplets 38. Rather, material 40 is deposited on mold 26 to cover the features of the pattern as a contiguous film of material 40. To that end, material 40 may be disposed in a transfer platen 47, shown in FIG. 6, which may be selectively disposed between mold 26 and substrate 32, or positioned adjacent to substrate 32, with mold 26 selectively positioned to be in superimposition therewith. Mold 26 is placed in contact with material 40 contained in platen 47. The area of platen 47 is established so that the entire area of mold 26 may be placed in contact with material 40 contained in platen 47. It is conceivable that this dip-coating technique may be employed to create a self-assembled monolayer of material 40 on mold 26 not unlike a Langmiur-Blodgette monolayer.

Referring to FIGS. 1, 2 and 3, the characteristics of material 40 are important to efficiently pattern substrate 32 in light of the unique deposition process employed. As mentioned above, material 40 is deposited on mold 26. The volume of material on mold 26 is such that the material 40 is distributed appropriately over an area of surface 36 where imprinting layer 34 is to be formed. In this fashion, the total volume of imprinting material 40 present on mold 26 defines the distance “d” to be obtained so that the total volume occupied by material 40 in the gap defined between patterned mold 26 and the portion of substrate 32 in superimposition therewith once the desired distance “d” is reached is substantially equal to the total volume of material 40 in droplets 38. As a result, imprinting layer 34 is spread and patterned concurrently with the pattern being subsequently set by exposure to radiation, such as ultraviolet radiation and/or thermal radiation/energy. To facilitate the deposition process, it is desired that material 40 have certain characteristics to provide rapid and even coverage of material 40 over surface 36 so that the all thicknesses t₁ are substantially uniform and all residual thicknesses t₂ are substantially uniform.

An exemplary composition for material 40 is silicon-free and consists of the following:

### Composition 1

### isobornyl acrylate

### n-hexyl acrylate

### ethylene glycol diacrylate

### 2-hydroxy-2-methyl-1-phenyl-propan-1-one

In COMPOSITION 1, isobornyl acrylate comprises approximately 55% of the composition, n-hexyl acrylate comprises approximately 27%, ethylene glycol diacrylate comprises approximately 15% and the initiator 2-hydroxy-2-methyl-1-phenyl-propan-1-one comprises approximately 3%. The initiator is sold under the trade name DAROCUR® 1173 by CIBA® of Tarrytown, N.Y. The above-identified composition also includes stabilizers that are well known in the chemical art to increase the operational life of the composition. To provide suitable release properties, COMPOSITION 1 may be employed with a template treated to have a mold surface that is hydrophobic and/or low surface energy, e.g., an a priori release layer.

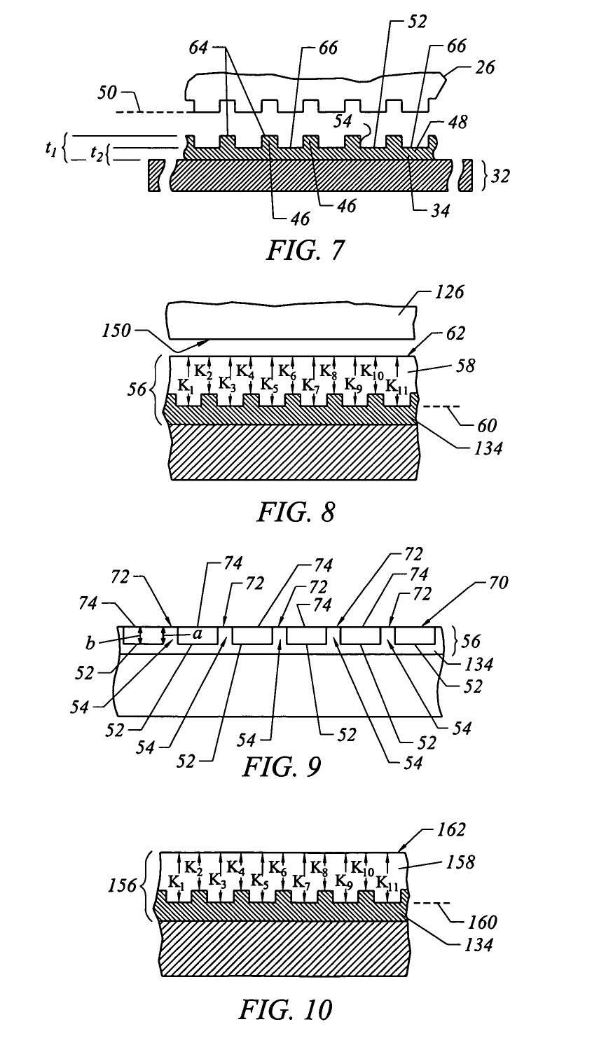

Referring to FIGS. 3 and 7, to improve the release properties of patterned mold 26 and solidified imprinting layer 134 and to ensure that solidified imprinting layer 134 does not adhere to patterned mold 26, an additive may be included in COMPOSITION 1. To that end, material 40 may include, as an additive, a surfactant. For purposes of this invention a surfactant is defined as any molecule, one tail of which is hydrophobic. Surfactants may be either fluorine-containing, e.g., include a fluorine chain, or may not include any fluorine in the surfactant molecule structure. An exemplary surfactant is available under the trade name ZONYL® FSO-100 from DUPONT™ that has a general structure of R₁R₂, where R₁═F(CF₂CF₂)_{Y} with y being in a range of 1 to 7, inclusive, and R₂═CH₂CH₂O(CH₂CH₂O)_{X}H with X being in a range of 0 to 15, inclusive. This provides material 40 with the following composition:

### Composition 2

### isobornyl acrylate

### n-hexyl acrylate

### ethylene glycol diacrylate

### 2-hydroxy-2-methyl-1-phenyl-propan-1-one

### R_{f}CH₂CH₂O(CH₂CH₂O)_{X}H,

The ZONYL® FSO-100 additive comprises less than 1% of the composition with the relative amounts of the remaining components being as discussed above with respect to COMPOSITION 1. However, the percentage of ZONYL® FSO-100 may be greater than 1%.

Each of COMPOSITIONS 1 and 2 are electrically non-conductive, i.e., COMPOSITIONS 1 and 2 are dielectric materials. As a result, COMPOSITIONS 1 and 2 may be employed to form a single level metallized device. Specifically, by forming solidified imprinting layer 134 with a desired pattern, an electrically conductive layer may be disposed adjacent to solidified imprinting layer 134. In this manner, a desired single level electrical circuit may be formed.

Referring to FIG. 5, COMPOSITIONS 1 and 2 may be doped with a conductive component, such as polyanyline, carbon-black and graphite, to form a conductive material. The conductive material would be employed to form a multi-layered structure 56 by forming a conductive conformal layer 58 adjacent to solidified imprinting layer 134. Specifically, the conductive material may be deposited adjacent to solidified imprinting layer 134 using any known technique to form conformal layer 58, such as the technique discussed above with respect to deposition of material 40. Alternatively, the conductive material may be deposited adjacent to solidified imprinting layer 134 employing spin-coating techniques, discussed more fully below.

Referring to both FIGS. 2 and 8, when deposition occurs employing the techniques discussed above, patterned mold 26 is replaced with a planarization mold 126. Planarization mold 126 has a substantially smooth, if not planar, surface 150. Surface 150 contacts droplets 38, causing the same to spread in a manner discussed above, excepting that conformal layer 58 is formed having a smooth, if not substantially planar, surface referred to as a normalization surface 62. The shape of normalization surface 62 matches the profile of surface 150. Typically, planarization mold 126 is an optical flat that has sufficient area to concurrently planarize all regions of substrate 32 that includes conductive material employed to form conformal layer 58. Thereafter, the conductive material in conformal layer 58 is solidified and planarization mold 126 is separated from conformal layer 58. In this manner, conformal layer 58 includes first and second opposed sides. First side 60 faces imprinting layer 134 and has a profile complementary to the profile of the imprinting layer 134. The second side faces away from imprinting layer 134, forming normalization surface 62.

As a result of the topography of normalization surface 62, distances k₂, k₄, k₆, k₈ and k₁₀ between an apex 64 of each of protrusions 54 and normalization surface 62 are substantially the same. Similarly, the distances k₁, k₃, k₅, k₇, k₉ and k₁₁ between a nadir surface 66 of each of recessions 52 and normalization surface 62 are substantially the same.

Referring to FIGS. 8 and 9, after formation of normalization surface 62, a blanket etch is employed to remove portions of conformal layer 58 to provide multi-layered structure 56 with a crown surface 70. For example and without limitation, the blanket etch may be achieved in a system available from LAM Research 9400SE obtained from Lam Research, Inc. of Fremont, Calif. In this manner, normalization surface 62 is subjected to an isotropic halogen reactive ion etch (“RIE”) rich in fluorine, i.e., wherein at least one of the precursors was a fluorine-containing material, for example, and without limitation, a combination of CHF₃ and O₂. Other suitable halogen compounds include, for example, and without limitation, CF₄. Normalization surface 62 is subjected to the blanket etch sufficient to expose crown surface 70.

Crown surface 70 is defined by an exposed surface 72 of each of electrically insulative protrusions 54 and upper surfaces of electrically conductive portions 74 that remain on conformal layer 58 after the blanket etch. The composition of conformal layer 58 is such that when the blanket etch is applied to conformal layer 58, crown surface 70 is provided with a substantially planar profile. That is, the thickness of protrusions 54, shown as “a,” is substantially the same as the thickness of portions 74, shown as “b.” An exemplary blanket etch may be a plasma etch process employing a fluorine-based chemistry. In this manner, single level circuits may be formed consisting of electrically conductive portions 74 separated by electrically insulative protrusions 54.

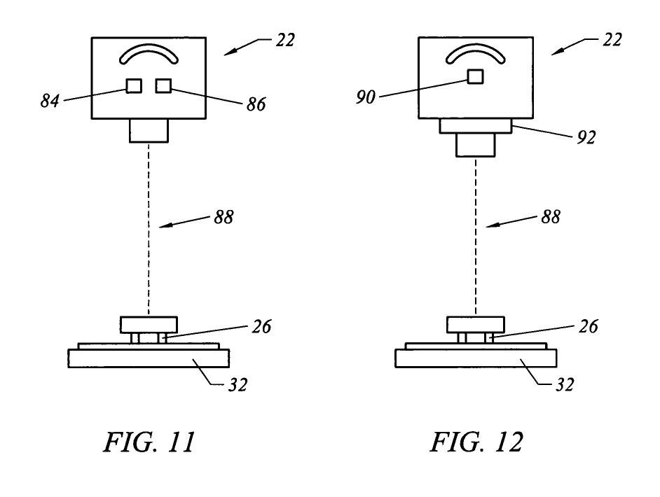

Referring to FIGS. 8 and 11, as discussed above, single level circuits may be formed by formation of conformal layer 58 employing spin-on and thermal curing techniques. To that end, exemplary material that may be employed to form conformal layer 158 includes a silicon-containing composition that is doped with a conductive material, such as polyanyline, carbon black and graphite. An exemplary silicon-containing composition includes a silicone resin, a cross-linking agent, a catalyst, and a solvent.

The silicone resin is process compatible, satisfying ionic, purity, and by-product contamination requirements desired. The cross-linking agent is included to cross-link the silicone resin, providing conformal layer 158 with the properties to record a pattern thereon having very small feature sizes, i.e., on the order of a few nanometers. To that end, the catalyst is provided to produce a condensation reaction in response to thermal energy, e.g., heat, causing the silicone resin and the cross-linking agent to polymerize and to cross-link, forming a cross-linked polymer material. The solvent selected is compatible with the silicone resin and represents the remaining balance of the conductive material. It is desired that the solvent minimize, if not avoid, causing distortions in solidified imprinting layer 134 due, for example, to swelling of solidified imprinting layer 134.

The silicone resin can be any alkyl and/or aryl substituted polysiloxane, copolymer, blend or mixture thereof. Examples of a silicone resin include ultraviolet (UV) curable sol-gels; UV curable epoxy silicone; UV curable acrylate silicone; UV curable silicone via thiolene chemistry; and non-cured materials, such as hydrogen silsesquioxanes; and poly(meth)acrylate/siloxane copolymers. Preferably, a hydroxyl-functional polysiloxane is used, such as a hydroxyl-functional organo-siloxane, with examples of organo-siloxanes including methyl, phenyl, propyl and their mixtures. The silicone resin may be present in the conductive composition in amounts of approximately 2% to 40% by weight, depending on the thicknesses desired for conformal layer 158. An exemplary example of a hydroxyl-functional polysiloxane used in the present invention is a silicon T-resin intermediate available from Dow Corning® of Midland, Mich. under the trade name Z-6018.

The cross-linking agent is a compound that includes two or more polymerizable groups. The cross-linking agent may be present in the conductive composition in amounts of approximately 2% to 50% by weight in relation to the quantity of silicone resin present. Typically, the cross-linking agent is present in the conductive composition in an amount of approximately 20% to 30%. An exemplary example of a cross-linking agent used in the present invention is a hexamethoxymethylmelamine(HMMM)-based aminoplast cross-linking agent available from Cytec Industries, Inc. of West Paterson, N.J. under the trade name CYMEL 303ULF.

The catalyst may be any component that catalyzes a condensation reaction. Suitable catalysts may include, but are not limited to, acidic compounds, such as sulfonic acid. The catalyst may be present in the conductive material in amounts of approximately 0.05% to 5% by weight in relation to the silicone resin present. Typically, the catalyst is present in the conductive material in an amount of approximately 1% to 2%. An exemplary example of a catalyst used in the present invention is toluenesulfonic acid available from Cytec Industries, Inc. of West Paterson, N.J. under the trade name CYCAT 4040.

For the balance of the composition, a solvent is utilized. The solvent can be any solvent or combination of solvents that satisfies several criteria. As mentioned above, the solvent should not cause solidified imprinting layer 134 to swell. In addition, the evaporation rate of the solvent should be established so that a desired quantity of the solvent evaporates as a result of the spin-coating process while providing sufficient viscosity to facilitate planarization of the conductive material in furtherance of forming conformal layer 158. Suitable solvents may include, but are not limited to, alcohol, ether, a glycol or glycol ether, a ketone, an ester, an acetate and mixtures thereof. The solvent may be present in the conductive material used to form conformal layer 158 in amounts of approximately 60% to 98% by weight, dependent upon the desired thicknesses of conformal layer 158. An exemplary example of a solvent used in the present invention is methyl amyl ketone available from Aldrich Co. of St. Louis, Mo. under the trade name MAK.

In a further embodiment, the composition of conformal layer 158 is altered to include an epoxy-functional silane coupling agent to improve the cross-linking reaction and to improve the rate of cross-linking. Examples of epoxy-functional silanes may include glycidoxymethyltrimethoxysilane, 3-glycidoxypropyltrihydroxysilane, 3-glycidoxypropyldimethylhydroxysilane, 3-glycidoxypropyltrimeth oxysilane, 2,3-epoxypropyltrimethoxysilane, and the like. The epoxy-functional silane may be present in conformal layer 158 in amounts of approximately 2% to 30% by weight of conductive compound in relation to the silicone resin and typically in an amount of 5% to 10%. An exemplary example of epoxy-functional silane used in the present invention is gamma-glycidoxypropyltrimethoxysilane available from GE Silicone/OSi Specialty of Wilton, Conn. under the trade name A187.

Exemplary compositions from which to form conformal layer 158 are as follows:

### Composition 3

### hydroxyl-functional polysiloxane

### hexamethoxymethylmelamine

### toluenesulfonic acid

### methyl amyl ketone

### Composition 4

### hydroxyl-functional polysiloxane

### hexamethoxymethylmelamine

### gamma-glycidoxypropyltrimethoxysilane

### toluenesulfonic acid

### methyl amyl ketone

In COMPOSITION 3, hydroxyl-functional polysiloxane comprises approximately 4% of the composition, hexamethoxymethylmelamine comprisies approximately 0.95%, toluenesulfonic acid comprises approximately 0.05% and methyl amyl ketone comprises approximately 95%. In COMPOSITION 4, hydroxyl-functional polysiloxane comprises approximately 4% of the composition, hexamethoxymethylmelamine comprises approximately 0.7%, gamma-glycidoxypropyltrimethoxysilane comprises approximately 0.25%, toluenesulfonic acid comprises approximately 0.05%, and methyl amyl ketone comprises approximately 95%.

Both COMPOSITIONS 3 and 4 are made up of at least 4% of the silicone resin. Upon curing, however, the quantity of silicon present in conformal layer 158 is at least 5% by weight and typically in a range of 20% or greater. Specifically, the quantity and the composition of the solvent present in COMPOSITIONS 3 and 4 are selected so that a substantial portion of the solvent evaporates during spin-coating application of the COMPOSITION 3 or 4 on solidified imprinting layer 134. In the present exemplary conductive material, approximately 90% of the solvent evaporates during spin-coating. Upon exposing the conductive material to thermal energy, the remaining 10% of the solvent evaporates, leaving conformal layer 158 with approximately 20% silicon by weight.

An exemplary method of forming conformal layer 158 includes spinning-on approximately 4 mL of the conductive material deposited proximate to a center of solidified imprinting layer 134. To that end, substrate 32 is spun at 1000 rev/min for 1 minute by placing substrate 32 on a hot plate. Thereafter, the conductive material is subjected to thermal energy by baking at 150° C. for 1 minute. This produces the conductive material from which conformal layer 158 is formed with thickness variations of 20 nm or less. Were it desired to increase the thickness of the solidified conductive layer, e.g., to provide the solidified conductive layer with a thickness of 200 nm, the aforementioned spin-coating and curing processes are simply repeated. As a result, the solvent employed is selected so as not to remove, “wash away,” the conductive material in a well-cured conformal layer 158.

Referring to FIG. 10, the spin-coating and curing processes provide conformal layer 158 first and second opposed sides. First side 160 faces imprinting layer 134 and has a profile complementary to the profile of imprinting layer 134. The second side faces away from imprinting layer 134 forming normalization surface 162, which is substantially smooth and typically planar and without necessitating implementation of planarization mold 126. In this manner, normalization surface 162 provides solidified conformal layer 158 with a substantially normalized profile. It is believed that normalization surface 162 is provided with a smooth, e.g., substantially planar, topography by ensuring that COMPOSITIONS 3 and 4 have a glass transition temperature lower than the curing temperature. Specifically, it is desired that the temperature difference between the glass transition temperature and the curing temperature be sufficient to allow the conductive material to reflow during curing to maximize smoothness, e.g., planarity of normalization surface 162, in a minimum amount of time. For example, the COMPOSITIONS 3 and 4 each have a glass transition temperature of approximately 50° C. and a curing temperature of 150° C. As a result of the topography of normalization surface 162, the distances k₂, k₄, k₆, k₈ and k₁₀ between apex 64 of each of protrusions 54 and normalization surface 162 are substantially the same. Similarly, the distances k₁, k₃, k₅, k₇, k₉ and k₁₁ between nadir surface 66 of each of recessions 52 and normalization surface 162 are substantially the same.

It has been found that additional planarization may be desired when forming conformal layer 158. To that end, the silicon-containing conductive material may be deposited as a plurality of droplets as discussed above with respect to forming conformal layer 58, or may be spun-on. After deposition of the silicon-containing conductive material, planarization mold 126 is employed to further planarize normalization surface 162. Thereafter, the silicon-containing conductive material is solidified and planarized mold 126 is separated from conformal layer 158. Thereafter, conformal layer 158 is processed as discussed above to form single level circuits.

Referring to both FIGS. 2, 8 and 11, it may be desired to implement a step and repeat planarization process when forming conformal layer 58. To that end, radiation source 22 may be selected to provide actinic radiation to effectuate cross-linking using both infrared (IR) radiation and ultraviolet radiation. An exemplary radiation source 22 may include multiple sources, each of which produces a single range of wavelengths of radiation, and is shown including two radiation sources 84 and 86. Radiation source 84 may be any known in the art capable of producing IR radiation, and radiation source 86 may be any known in the art capable of producing actinic radiation employed to polymerize and to cross-link material in droplets 38, such as UV radiation. Specifically, radiation produced by either of sources 84 and 86 propagates along optical path 88 toward substrate 32. A circuit (not shown) is in electrical communication with radiation sources 84 and 86 to selectively allow radiation in the UV and IR spectra to impinge upon substrate 32.

Referring to FIG. 12, alternatively, radiation source 22 may include a single radiation source that produces multiple ranges of wavelength, which may be selectively controlled to impinge upon substrate 32 sequentially or concurrently. An exemplary radiation source 22 consists of a single broad spectrum radiation source 90 that produces UV and IR radiation, which may consist of a mercury (Hg) lamp. To selectively impinge differing types of radiation upon substrate 32, a filtering system 92 is utilized. Filtering system 92 comprises a high pass filter (not shown) and a low pass filter (not shown), each in optical communication with radiation source 90. Filtering system 92 may position the high pass filter (not shown) such that optical path 88 comprises IR radiation or filtering system 92 may position the low pass filter (not shown) such that optical path 88 comprises UV radiation. The high pass and low pass filters (not shown) may be any known in the art, such as interference filters comprising two semi-reflective coatings with a spacer disposed therebetween. The index of refraction and the thickness of the spacer determine the frequency band being selected and transmitted through the interference filter. Therefore, the appropriate index of refraction and thickness of the spacer is chosen for both the high pass filter (not shown) and the low pass filter (not shown), such that the high pass filter (not shown) permits passage of IR radiation and the low pass filter (not shown) permits passage of UV radiation. A processor (not shown) is in data communication with radiation source 90 and filtering system 92 to selectively allow the desired wavelength of radiation to propagate along optical path 88. The circuit enables the high pass filter (not shown) when IR radiation is desired and enables the low pass filter (not shown) when UV radiation is desired.

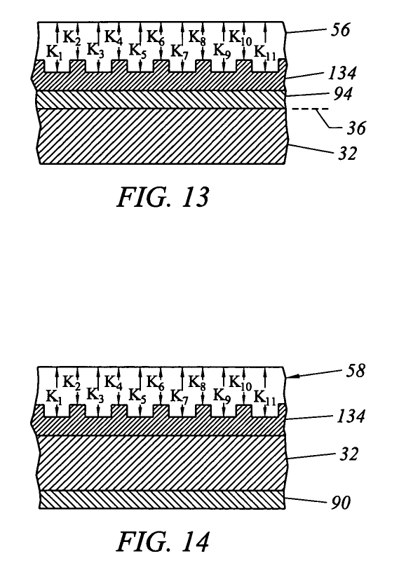

Referring to FIG. 13, substrate 32 may have one or more existing layers disposed thereon before deposition of imprinting layer 34. As a result, heating the conductive material may be problematic because the material from which the wafer is formed and/or the preexisting layers on the wafer, e.g., solidified imprinting layer 134, are substantially non-responsive to infrared radiation. As a result, very little energy transfer may occur, resulting in it being difficult to raise the temperature of the conductive material sufficient to achieve cross-linking.

To facilitate cross-linking of the conductive material in one of conformal layers 58 and 158, one of the layers included with substrate 32 may be an infrared absorption layer 94. Absorption layer 94 comprises a material that is excited when exposed to IR radiation and produces a localized heat source. Typically, absorption layer 94 is formed from a material that maintains a constant phase state during the heating process, which may include a solid phase state. Specifically, the IR radiation impinging upon absorption layer 94 causes an excitation of the molecules contained therein, generating heat. The heat generated in absorption layer 94 is transferred to the conductive material via conduction through the wafer and/or any intervening layer of material thereon, e.g., absorption layer 94 may be disposed on surface 36 so as to be disposed between substrate 32 and solidified imprinting layer 134. As a result, absorption layer 94 and substrate 32 provide a bifurcated heat transfer mechanism that is able to absorb IR radiation and to produce a localized heat source sensed by the conductive material in one of conformal layers 58 and 158. In this manner, absorption layer 94 creates a localized heat source on surface 36. To that end, absorption layer 94 may be deposited using any known technique, including spin-coating, chemical vapor deposition, physical vapor deposition, atomic layer deposition and the like. Exemplary materials may be formed from a carbon-based PVD coating, organic thermo set coating with carbon black filler or molybdenum disulfide (MoS₂) based coating.

Referring to FIG. 14, absorption layer 94 may be disposed on a side of substrate 32 disposed opposite to solidified imprinting layer 134. As a result, absorption layer 94 may be permanently or removably attached. Exemplary materials that may be employed as absorption layer 94 include black nickel and anodized black aluminum. Also, black chromium may be employed as absorption layer 94. Black chromium is typically deposited as a mixture of oxides and is used as a coating for solar cells.

Furthermore, as shown in FIG. 2, patterned mold 26 may be fabricated from any material, such as, but not limited to, fused-silica, quartz, silicon, organic polymers, siloxane polymers, borosilicate glass, fluorocarbon polymers, metal, and combinations of the above. However, in the present embodiment, the actinic radiation propagates through patterned mold 26. Therefore, it is desired that patterned mold 26 be fabricated from material that is substantially transparent to the actinic radiation. The plurality of features on patterned mold 26 are shown as recesses 28 extending along a direction parallel to projections 30 that provide a cross-section of patterned mold 26 with a shape of a battlement. However, recesses 28 and projections 30 may correspond to virtually any feature required to create an integrated circuit and may be as small as a few tenths of nanometers.

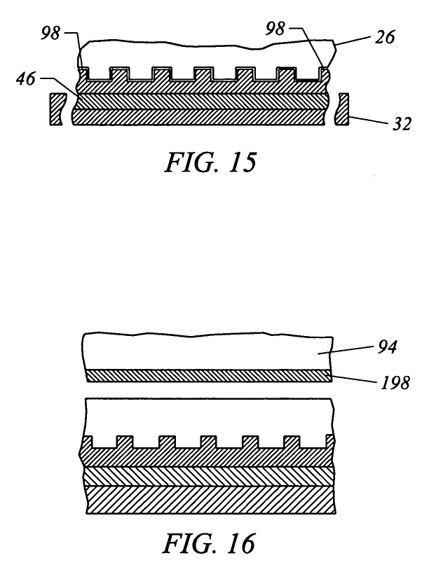

Referring to FIGS. 2 and 15, similarly, it may be desirable to provide substrate 32 with a planarized surface upon which to form imprinting layer 34. To that end, a primer layer 96 may be formed upon substrate 32. Primer layer 96 has proved beneficial when surface 36 of substrate 32 appears rough as compared to the feature dimensions to be formed in imprinting layer 34. Additionally, it has been found beneficial to deposit primer layer 96 when forming imprinting layer 34 upon a previously disposed patterned layer present on substrate 32. Primer layer 96 may also function, inter alia, to provide a standard interface with imprinting layer 34, thereby reducing the need to customize each process to the material from which substrate 32 is formed. In addition, primer layer 96 may be formed from an organic material with the same etch characteristics as imprinting layer 34. Primer layer 96 is fabricated in such a manner so as to possess a continuous, smooth, relatively defect-free surface that may exhibit excellent adhesion to imprinting layer 34. An exemplary material to use to form primer layer 96 is available from Brewer Science, Inc. of Rolla, Mo. under the trade name DUV30J-6

Referring to FIGS. 7 and 15, to reduce the probability that solidified imprinting layer 134 does not adhere to patterned mold 26, surface 50 may be treated with a low surface energy coating 98. Low surface energy coating 98 may be applied using any known process. For example, processing techniques may include chemical vapor deposition method, physical vapor-deposition, atomic layer deposition or various other techniques, brazing and the like. In a similar fashion, a low surface energy coating 198 may be applied to planarization mold 126, shown in FIG. 14. Typically, the surfactant has a surface energy associated therewith that is lower than a surface energy of the polymerizable material in the layer. An exemplary material and process by which to form the aforementioned surfactant is discussed by Bender et al. in MULTIPLE IMPRINTING IN UV-BASED NANOIMPRINT LITHOGRAPHY:RELATED MATERIAL ISSUES, Microelectronic Engineering pp. 61-62 (2002). The low surface energy of the surfactant provides the desired release properties to reduce adherence of either imprinting layer 34 or conformal layers 58 and 158 to patterned mold 26 or planarization mold 126. It should be understood that the surfactant may be used in conjunction with, or in lieu of, low surface energy coatings 98 and 198.

The embodiments of the present invention described above are exemplary. Many changes and modifications may be made to the disclosure recited above, while remaining within the scope of the invention. The scope of the invention should, therefore, be determined not with reference to the above description, but instead should be determined with reference to the appended claims along with their full scope of equivalents.

1. A method for dispensing a fluid having a surface tension associated therewith on a substrate, said method comprising:
contacting said substrate with a volume of said fluid having a mass, with said mass defining a force, with said force being less than said surface tension, whereby said volume avoids shedding in response to gravity.

2. The method as recited in claim 1 wherein contacting further includes depositing said volume as a plurality of discrete droplets, each of which has said mass.

3. The method as recited in claim 1 wherein contacting further includes depositing said volume as a contiguous layer over an area of said substrate.

4. The method as recited in claim 1 wherein said substrate includes a recess and contacting further includes dispensing a droplet into said recess.

5. The method as recited in claim 1 wherein said substrate includes a plurality of recesses and contacting further includes dispensing a droplet into a subgroup of said plurality of recesses, with said plurality of recesses having a volume, with said volume of said fluid being less than said volume of said plurality of recesses.

6. The method as recited in claim 1 wherein said substrate includes a recess and contacting further includes dispensing a droplet of said fluid into said recess, with said volume being established to fill said recess by capillary action.

7. The method as recited in claim 1 wherein said substrate includes a recess and contacting further includes dispensing multiple droplets into said recess, each of said multiple droplets having a quantity of said fluid, with said quantity being less than said volume of said recess so that filling of said recess occurs by capillary action.

8. The method as recited in claim 1 further including transferring said volume to an adjacent surface by contacting said surface with said volume.

9. The method as recited in claim 1 further including transferring said volume to form a contiguous layer of said fluid on an adjacent surface.

10. The method as recited in claim 1 wherein contacting further includes depositing said volume on said substrate and an adjacent surface spaced-apart from said substrate.

11. A method for dispensing a fluid having a surface tension associated therewith on a substrate, said method comprising:
directing a fluid toward said substrate against gravity to deposit a volume thereon, with said volume having a mass defining a force, with said force being less than said surface tension, whereby said volume avoids shedding under force of gravity.

12. The method as recited in claim 11 wherein said substrate includes a recess and directing further includes dispensing a droplet into said recess, with said recess having a volume, with said volume of said fluid being sufficient to fill said recess through capillary action.

13. The method as recited in claim 11 wherein directing further includes depositing said volume as a plurality of discrete droplets, each of which has said mass.

14. The method as recited in claim 11 wherein contacting further includes depositing said volume as a contiguous layer over an area of said substrate.

15. The method as recited in claim 11 wherein said substrate includes a plurality of recesses defining a pattern and directing further includes dispensing a droplet onto said substrate, with said plurality of recesses having a volume and said volume of said fluid being sufficient to fill said volume of said plurality of recesses.

16. The method as recited in claim 11 wherein said substrate includes a recess and directing further includes dispensing a droplet of said fluid into said recess, with said volume being established to fill said recess by capillary action.

17. The method as recited in claim 16 further including transferring said volume to an adjacent surface by contacting said surface with said volume.

18. The method as recited in claim 17 further including transferring said volume to form a contiguous layer of said fluid on an adjacent surface.

19. The method as recited in claim 18 wherein dispensing further includes establishing said volume to fill said recess by capillary action and form a contiguous layer over an area of said substrate.

20. The method as recited in claim 11 wherein contacting further includes depositing said volume on said substrate and an adjacent surface spaced-apart from said substrate.

21. A method for dispensing a fluid having a surface tension associated therewith on a substrate, said method comprising:
contacting said substrate with a volume of said fluid having a mass, with said mass defining a force, with said force being less than said surface tension, whereby said volume avoids shedding in response to gravity; and
transferring said volume to an adjacent surface by contacting said surface with said volume.

22. The method as recited in claim 21 wherein transferring further includes forming from said volume a contiguous layer of said fluid on said adjacent surface.

23. The method as recited in claim 22 wherein said substrate includes a plurality of recesses and contacting further includes dispensing a portion of said volume into said plurality of recesses.

24. The method as recited in claim 23 wherein said recess defines a pattern and said portion fills substantially all of said recess by capillary action.

25. The method as recited in claim 23 wherein said portion fills a sub-section of said recess by capillary action.

26. The method as recited in claim 24 wherein contacting further includes depositing said volume as a plurality of discrete droplets, each of which has said mass.

27. The method as recited in claim 24 wherein contacting further includes depositing said volume as a contiguous layer over an area of said substrate.

28. The method as recited in claim 21 wherein contacting further includes depositing said volume on said substrate and said adjacent surface.
